(19) United States
(12) Patent Application Publication
(10) Pub. No.: US 2014/0152490 A1
(43) Pub. Date: Jun. 5, 2014

(54) Method and Arrangement for the Detection of an Object in a Radar Field

(71) Applicant: Michael LEHNING, Hildesheim (DE)

(72) Inventor: Michael LEHNING, Hildesheim (DE)

(21) Appl. No.: 13/692,618

(22) Filed: Dec. 3, 2012

(51) Int. Cl. G01S 7/40

(52) U.S. Cl. CPC G01S 7/4052
USPC 342/169

(57) ABSTRACT

A method and arrangement for detecting an object in a radar field (2.2) in which a simulator (3) arranged in a stationary manner in a radar field (2.2) of a radar device (2), which is outfitted with a radar transmitter (2.1) and a radar receiver (2.3), is suitable for simulating a speed profile which is defined by temporally consecutive speed changes. The simulator (3) is actuated in such a way that it simulates at least one predetermined atypical speed profile which cannot be associated with any expectable moving object so that, in addition to reflection signals from objects moving through the radar field (2.2), the radar receiver (2.3) receives simulator signals caused by the simulator (3), and status information associated with the atypical speed profile derived from these simulator signals.

### RELATED APPLICATIONS

The present application claims priority benefit of German Application No. DE 10 2011 056 432.2 filed on Dec. 14, 2011, the contents of which are incorporated by reference in their entirety.

### BACKGROUND OF THE INVENTION

The invention is directed to a method for the detection of an object in a radar field and to an arrangement for implementing the method.

It is known from the art to use radar radiation to detect speeds of moving objects. The possibility of measuring a distance and an angular position of an object relative to the radar device by means of radar radiation is likewise known.

Particularly when using mobile radar devices and radar devices employed for the acquisition of and probative documentation of measurement data, it is necessary to routinely check these measurement data. It is known for purposes of checking and aligning the radar device to install a simulator in the radar field of the radar device to be tested and to simulate a known speed of an imaginary radar target. If the position of the simulator relative to the radar device is known exactly, the simulator can also be used to check the distance measuring functions and angle measuring functions of the radar device.

Simulators may be mechanically operating devices in which a rotor rotates at a known speed. A simulator of this kind is described, for example, in EP 1 750 141 B1. The rotor can be provided with rotor blades and is coated with a material which is reflective for radar waves.

Solutions based on the use of rotors for simulating Doppler signals are also known, where U.S. Pat. No. 3,142,059 A and U.S. Pat. No. 4,517,569 A are cited by way of example. In this case, a rotor having a quantity of radial reflecting structures rotates in a housing acting as reflector. As a result of the design of the housing, rotor and reflecting structures, a Doppler signal is superposed with the radar signals which impinge on the simulator and which are reflected by it.

A coded coherent transponder containing a receiver and a transmitter is known from DE 30 00 867 A. An interrogation signal is received by a receiver and a coherent response signal, including predetermined coded information, is transmitted by a transmitter. The coherent response signal can be modulated by a suitable phase shifter device to include a complex coded phase shift so that a plurality of Doppler frequencies can be represented simultaneously. According to the teaching of DE 30 00 876 A, one response signal is generated per unit of time. The response signal must be broken down into components by a suitable algorithm and analyzed to determine whether it is a regular signal of a measured object or a different signal. If the analysis determines that at least two speeds are contained in the response signal, it is not assumed to be a regular signal. A positive identification of the response signal is possible only by juxtaposing the apparent Doppler frequencies with their relative amplitudes. This identification is limited to establishing that the given response signal originates from the transponder. Therefore, use of the solution according to DE 30 00 876 A requires a quite significant expenditure on apparatus and computational overhead.

A simulator which is suitable for reception of a radar signal and selective modulation thereof with a Doppler frequency is described in GB 2464780 A. The modulated signal simulates a moving object. A user can select the length of the simulated object so that objects, for example, vehicles, of different size and class, e.g., passenger cars, trucks or vehicles with trailers, can be simulated. The simulator can be used together with a radar device located on a different side of the roadway than the simulator.

In all of the known technical teachings of the prior art, simulators of this type are used to check for correct installation of radar sensors in a radar device and for checking that speed measurements carried out by the radar device conform to permissible deviations.

If additional information must be taken into account in the operation of a radar device, e.g., the current switch states of a traffic signal (referred to hereinafter as signal device for the sake of brevity) such as a traffic light (e.g., the “red”, “yellow” and “green” switch states), the maximum permissible speed which is adjustably displayed by a variable message sign (hereinafter: matrix sign), or a command or prohibition displayed by some other signal device, this information is conveyed directly to the radar device. Since a radar device is typically arranged at a considerable distance from the given signal device, the information, e.g., concerning the current switch states of the signal device, is conveyed to the radar device via wired or wireless data lines. Wired data lines are disadvantageous particularly when longer distances must be covered or when roadways intervene between the signal device and the radar device. The transmission quality of wireless data lines, particularly in radio transmission, may be substantially compromised in case of greater transmission distances by surrounding buildings, moving traffic, and other sources of interference.

### SUMMARY OF THE INVENTION

It is an object of the invention to provide a novel solution for transmitting information to a radar device.

This object of the invention is achieved by a method for detecting an object in a radar field which is implemented by means of a simulator arranged in a stationary manner in a radar field of a radar device which is outfitted with a radar transmitter and a radar receiver. The simulator is suitable for simulating a speed profile which is defined by temporally consecutive speed changes. The simulator is actuated in such a way that it simulates at least one predetermined atypical speed profile which cannot be associated with any expectable moving object. Therefore, in addition to reflection signals from objects moving through the radar field, the radar receiver also receives simulator signals caused by the simulator. Status information associated with the atypical speed profile is derived from these simulator signals.

The invention provides that speed profiles which cannot be produced by an expected object, e.g., a vehicle, to be detected are simulated by selective actuation of the simulator. Certain information, for example, a current switch state of a signal device, is coded by means of atypical speed profiles of this kind and conveyed to the radar device.

In so doing, it is highly advantageous that speed profiles which can be used for checking the radar device can also be simulated by the same simulator. Therefore, the radar device can be checked when put into operation and also during its operation in that speeds or speed profiles (generally referred to as test speeds) which are suitable for checking are simulated. By simulator signals is meant hereinafter both test speeds and atypical speed profiles.

A speed profile within the meaning of this description is a determined sequence of simulated speeds, wherein the respective simulation duration of every speed is also determined. Further, the duration and form of the simulated transitions between the respective speeds (e.g., rectangular function, triangular function and slopes thereof) can be determined and used to describe and detect a speed profile. A speed profile can comprise a predetermined quantity and sequence of simulated speeds. The above statements also apply to atypical speed profiles.

Signal devices are intended herein to mean all devices by which optical and/or acoustic information are/is supplied and through which commands or prohibitions are conveyed to traffic participants.

In a preferred embodiment of the method according to the invention, the atypical speed profile is determined by abruptly changing speeds. For example, particular sequences of speeds and, concomitantly, a particular sequence of speed changes can be simulated which cannot be achieved at all by a real vehicle based on available driving and braking capabilities of the vehicles, response times of the drivers or other technical and physical restrictions. For example, it is possible to simulate alternating identical changes in speed of 50 km/h, respectively, within fractions of seconds. It is also possible to simulate disparate speed changes and to configure the temporal and quantitative sequence and the quantity of simulated speed changes of a sequence of simulated speed changes in ways other than those mentioned above.

By configuring the method in this way, it is possible to derive status information from such simulator signals as lie within a sensitivity of the radar receiver, which sensitivity is optimized for operation as specified. In particular, an atypical speed profile can be simulated by means of such speeds as lie within a predefined measurement range of the radar device. For example, the measurement range of a radar device can be configured for speeds between 20 and 300 km/h. The atypical speed profile is then simulated with speeds selected from this speed range. This makes it possible to use common radar devices and to do without auxiliary devices or sensors of the radar receiver with overdimensioned sensitivity for detection of atypical speed profiles. Further, an atypical speed profile to be simulated can advantageously be determined individually based on the technical characteristic of the radar device.

The method according to the invention is also suitable for detecting objects located within a line of sight between the radar device and the simulator. When simulator signals are received unchanged, e.g., with unchanged speeds, distances and/or angles, status information is deduced therefrom to the effect that no object is located in the line of sight between the radar device and the simulator. Correspondingly, when there is no reception of simulator signals, the status information is deduced to the effect that at least one object is located in the line of sight. Nonreception is also to be equated with a weakening of the simulator signals below a determined threshold value. Accordingly, it also is possible to use the simulator and radar device as light barrier. In so doing, stationary objects as well as moving objects can be detected.

### SUMMARY OF EMBODIMENTS OF THE INVENTION

In a simple embodiment of the invention, the line of sight is an imaginary direct connection between simulator and radar device. In further embodiments, it can also be deflected by one or more reflectors so that the line of sight undergoes at least one change of direction between simulator and radar device.

In order to detect objects of different size classes, the course of the line of sight can be arranged in such a way that the height of the line of sight corresponds to a height of the objects to be detected (e.g., trucks or busses). For example, the simulator can be arranged at the edge of a roadway to be monitored and in an upper region of the radar field at a height above the greatest height of an average passenger car but below the greatest height of an average truck or bus. The line of sight extends in an ascending manner from the radar device to the simulator and is only interrupted when an object of corresponding height is located in the line of sight. In so doing, it must be ensured that the line of sight is not interrupted near the radar device by an object of low height.

It is also possible to arrange the line of sight in a descending or horizontal manner from the radar device to the simulator.

The method can also be used to derive from the reception of indeteiminately changed simulator signals the status information that a misalignment has occurred in the arrangement of radar device and simulator. An indeterminate change in the simulator signals is, for example, an unintended and persistent change of the angle at which the simulator signals are received.

A misalignment of this kind may be caused, for example, by an intentional change in the position of the radar device or by deliberate tampering with the radar device or simulator.

In an embodiment of the method according to the invention, the simulator is selectively actuated for simulation of different speed profiles in timed correspondence to changing switch states of a signal device in order to derive the different switch states as status information from the different simulator signals. Accordingly, a first atypical speed profile can be associated with a first switch state, e.g., “red” in a traffic light, while a second atypical speed profile is associated with a second switch state (e.g., “green”).

A switch state of the signal device is assigned to each atypical speed profile and the assignment is stored for repeated subsequent recall. Accordingly, an indication of the currently existing switch state is possible solely on the basis of the assignment of the atypical speed profiles to the switch states.

In a further embodiment of the method according to the invention, depending on the derived status information a camera is activated when the radar receiver receives reflection signals. In an embodiment of this kind, the method can be used for motion detection.

Use for motion detection is advantageous, for example, when a prohibition, e.g., no thoroughfare, is signalized by the signal device and unauthorized thoroughfare of a vehicle is to be detected.

In further embodiments of the method, the different switch states of a display of a signal device can relate to different permissible maximum speeds. The different simulator signals in this case represent different permissible maximum speeds and can be compared with speeds that were derived from the reflection signals.

In further embodiments of the method, it is also possible that the simulation by the simulator is completely terminated after the detection of an atypical speed profile, and a measurement is carried out according to the prior art until a further atypical speed profile is simulated. The termination of the simulation is preferably carried out after a predetermined simulation period.

When a comparison of the permissible maximum speed with the measured speed shows that the permissible maximum speed has been exceeded, the camera is actuated and the object is captured. It is also possible for the camera to be actuated regardless of whether or not the permissible maximum speed is exceeded, for example, for detecting the traffic flow and the types of vehicle passing through.

In a further embodiment of the method according to the invention, it is possible to use a plurality of radar devices whose radar fields overlap so that, notwithstanding possible shadows, reflection signals are always acquired when a vehicle passes through the overlapping region of the radar fields. In this case, the simulator is arranged in such a way that the radar receivers of the plurality of radar devices detect the simulator signals.

The above object of the invention is further achieved through an arrangement for implementing the method according to the invention with a radar device which is arranged in a stationary manner and which has a radar transmitter and a radar receiver. The radar device establishes a radar field in which the simulator is arranged in a stationary manner and, together with the radar device, the simulator forms a line of sight and is suitable for the simulation of at least one predefined atypical speed profile which cannot be associated with any expectable moving object and which is determined by temporally consecutive speed changes. Further, a simulator control is provided for actuating the simulator for simulation of different predefined speed profiles.

The simulator control preferably communicates with a signal device which can have different switch states. The simulator control is so configured that the simulator can be actuated simultaneous with the change in the switch state in order to simulate different atypical speed profiles during different switch states.

In an embodiment of the arrangement according to the invention, the simulator control can be integrated in the simulator or can be connected to it. In this way, a short transmission path between simulator control and signal device can be achieved in an advantageous manner. The simulator control preferably communicates wirelessly with a transmitting device of the signal device.

In another embodiment of the arrangement according to the invention, a camera, e.g., a video camera or a CCD camera, which is directed into the radar field is provided for recording images and can be actuated by a control which is signal-connected to the radar device.

The transmission of information from the signal device to the simulator can be carried out via wired or wireless data lines. Only short data lines are required because the simulator is preferably installed near (e.g., less than 5 m from) the signal device. It is advantageous that these short data lines are less prone to interference and are easier to handle than longer transmission paths. Wired data lines or radio-based data lines between the signal device and radar device can be dispensed with.

In a further development of the arrangement according to the invention, at least one reflector is arranged in the line of sight between radar device and simulator. This reflector can be a mirror which is reflective for radar radiation or a retroreflector, for example.

The line of sight can be folded at least once by means of this at least one reflector. A portion of the radar radiation of the radar field is reflected by the at least one reflector, and a further radar field (referred to hereinafter generally as second radar field) is defined by the reflected radar radiation.

By positioning a plurality of reflectors in a corresponding manner, the line of sight can also be folded multiple times and fanned out in the form of a curtain of second radar fields. The curtain of second radar fields creates a large horizontal area within which movements can be detected when a simulator is arranged in a second radar field. When the reception of simulator signals is interrupted or the simulator signals fall below a threshold value, it can be deduced from this that an object is located at some point in the line of sight between radar receiver and simulator. When radar device and simulator are used in this manner as light barrier, a large horizontal area with distances of as much as 100 m or more can be monitored. When using frequency modulated continuous wave radar with frequency shift keying (FMCW-FSK), information about the halting of an object in the line of sight can provide information about stationary vehicles which would otherwise be detectable only with FMCW without FSK.

It is also possible to make inferences about the length of the object from the duration over which an object resides in the line of sight and from the speed of the object derived from the reflection signals.

In further embodiments of the arrangement according to the invention, it is also possible to fold the radar field in vertical direction. In an embodiment such as this, the simulator can also be arranged above the radar device.

The arrangement according to the invention can be used for detecting objects, e.g., vehicles or persons, located in the line of sight. It is further suitable for detecting and documenting positions and speeds of at least one object located in the radar field. It is possible to use the arrangement for counting traffic. The method according to the invention and the arrangement according to the invention can be used for radar devices functioning in different ways, e.g., pulse radar, continuous wave (CW) radar, frequency modulated continuous wave radar (FMCW), and frequency modulated continuous wave radar with frequency shift keying (FMCW-FSK). Through the possibility of using the method and the arrangement as light barrier, FMCW-FSK type radar devices can also be used in a particularly advantageous manner for detecting stationary objects.

### BRIEF DESCRIPTION OF THE DRAWINGS

The invention will be described more fully in the following with reference to use examples, embodiment examples and illustrations. The drawings show:

FIG. 1 a first arrangement according to the invention with a simulator;

FIG. 2 a second arrangement according to the invention with a simulator and a reflector;

FIG. 3 a third arrangement according to the invention with a simulator in a second radar field; and

FIG. 3 a fourth arrangement according to the invention with elevated simulator.

### DESCRIPTION OF THE EMBODIMENTS

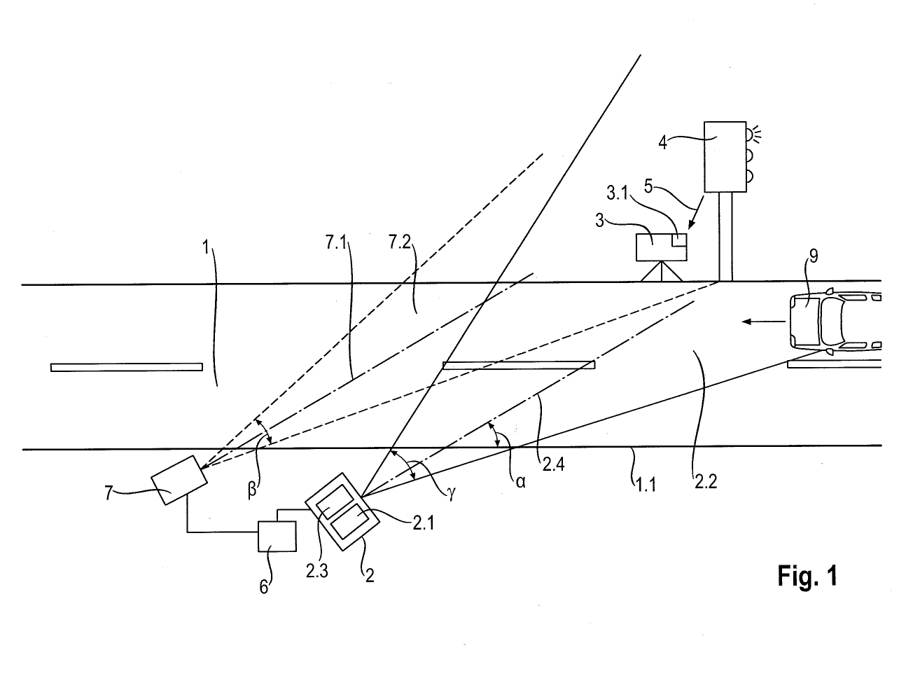

A first embodiment of an arrangement according to the invention shown in FIG. 1 essentially comprises a radar device 2 with a radar transmitter 2.1 for transmitting radar radiation, a radar receiver 2.3 for receiving reflected radar radiation in the form of reflection signals, and a simulator 3. The radar transmitter 2.1 and radar receiver 2.3 or, more precisely the transmitting and receiving surfaces thereof, are arranged so close together that their axes effectively form a common radar axis 2.4 around which a radar field 2.2 is formed, the size of which is defined by the horizontal radiating angle γ, the transmitting power of the radar transmitter 2.1 and the sensitivity of the radar receiver 2.3.

The radar device 2 is mounted at the edge 1.1 of a roadway 1 at an alignment angle α between radar axis 2.4 and edge 1.1 of the roadway 1. The size of the alignment angle α depends on the type of radar device 2 used and on the given rules for carrying out a usable measurement. The radar field 2.2 is radiated in the form of a radar lobe (shown here in a simplified manner as angular area) and extends along a portion of the roadway 1. On the opposite side of the roadway 1 from the radar device 2, the simulator 3 is installed in such a way that radar radiation impinging on the simulator 3 and changed by the simulator 3 is reflected back from the simulator 3 to the radar receiver 2.3 as simulator signals. The simulator 3 has a simulator control 3.1 which is connected by a wireless data line 5 (represented by an arrow) to a traffic light as signal device 4.

The radar receiver 2.3 is connected to a control 6 which is constructed as a storage/control unit and by means of which reflection signals and/or simulator signals received by the radar receiver 2.3 can be evaluated, converted into data packets and stored. The control 6 is connected to a camera 7. The camera 7 is so aligned that a camera axis 7.1 of the camera 7 is aligned at an angle in the region of the radar field 2.2. An object field 7.2 (indicated in dashed lines) which can partially overlap the radar field 2.2 is defined around the camera axis 7.1 by an aperture angle β of the camera 7.

To carry out the method according to the invention by means of a first arrangement according to FIG. 1, a continuous radar radiation of constant frequency and amplitude which defines the radar field 2.2 is radiated by means of the radar transmitter 2.1. A continuous speed measurement and a distance measurement are carried out making use of the Doppler radar effect and the principle of frequency key shifting (FSK), respectively, by evaluating the phase difference of reflected reflection signals of different frequencies.

The simulator 3 is actuated by the simulator control 3.1 in such a way that a test speed is simulated. In this simulation condition, the radar device 2 can be checked. On the one hand, the known simulated test speed can be checked for match against the speed determined by the radar device 2. On the other hand, the known relative position of the simulator 3 in the radar field 2.2 can be compared with and checked against the measured position of the simulator 3.

After checking is completed, one or more speed measurements can be carried out. Radar radiation reflected by a vehicle 9 moving in the radar field 2.2 is received by the radar receiver 2.3 as reflection signals and sent to the control 6. The measured speed of the vehicle 9 is compared with a permissible maximum speed. If the vehicle 9 is moving at an impermissibly high speed, the camera 7 is actuated by the control 6 and a picture is taken of the vehicle 9 and is stored together with the relevant measurement data (location, time, date, speed, etc.) for subsequent evaluation and processing.

In further embodiments of the invention, a plurality of pictures may also be taken.

Another use example of the method according to the invention by means of the arrangement is also described with reference to FIG. 1. Information about the current switch state “red” of the signal device 4 is sent to the simulator control 3.1 by the signal device 4 and via data line 5. Based on the information, the simulator 3 is actuated by the simulator control 3.1 and a first atypical speed profile is simulated which is received by the radar receiver 2.3, evaluated and sent to the control 6. The first atypical speed profile comprises a sequence of alternately simulated speeds of, e.g., 50-150-50-150- . . . km/h. Each speed is simulated for the duration of a radar pulse.

The atypical speed profiles and the associated switch states are stored for repeated subsequent recall as an assignment rule in the control 6 and in the simulator control 3.1. In so doing, each atypical speed profile is associated with a switch state of the signal device 4.

Moreover, in further embodiments, at least one atypical speed profile serves to signalize the start and/or end of the simulation of a test speed. The assignment rule contains a corresponding entry.

After the first atypical speed profile is detected, this first atypical speed profile is compared with an assignment to switch states of the signal device 4, which assignment is stored in the control 6, and the current switch state “red” is detected. Subsequently, the camera 7 is actuated for every detected vehicle 9 and documents the vehicle 9 even when the permissible maximum speed is obeyed. A red-light violation on the part of the driver of the vehicle is documented. At the same time, the measured speed of the vehicle 9 is compared with the permissible maximum speed and, if the permissible maximum speed is exceeded, the speed violation is also documented in addition to the red-light violation.

If a second atypical speed profile (e.g., a sequence of 30-300-30-300- . . . km/h) assigned to the “green” switch state is detected, the camera 7 is only actuated when the measured speed of the vehicle 9 is above the permissible maximum speed.

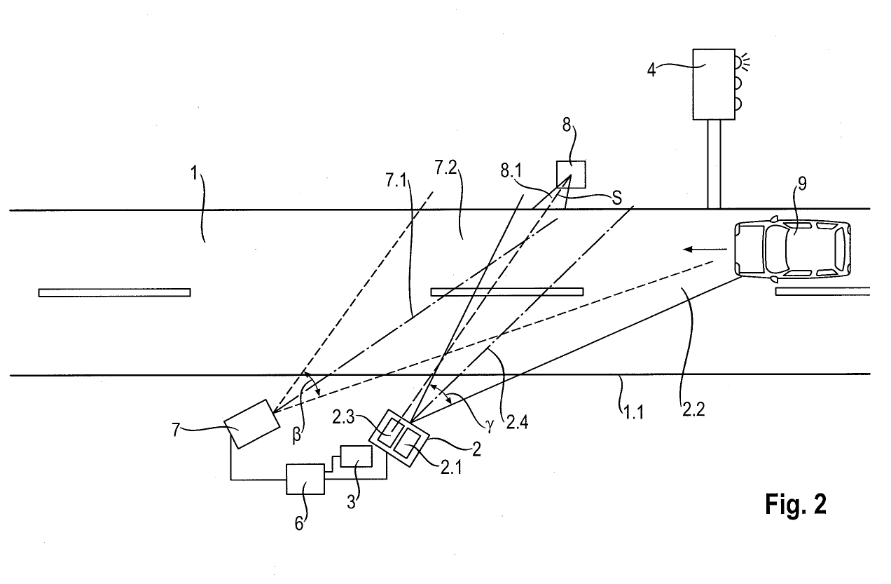

Another possible use of the first arrangement according to the invention shown in FIG. 1 consists in that an interruption of the reception of simulator signals during a simulation which is known to be currently taking place is evaluated as information about a vehicle 9 (not shown in this position) being located in the line of sight S (see FIGS. 2 and 4) between simulator 3 and radar receiver 2.3. If it is not permissible for the vehicle 9 to stop in the line of sight S at the time of detection, the camera 7 is actuated by the control 6 and a picture is taken of the vehicle 9.

As is shown in FIG. 2, a second arrangement has a retroreflector as reflector 8 which is provided in the radar field 2.2 on the opposite side of the roadway 1 from the radar device 2. A portion of the radar radiation is reflected by the reflector 8 into a second radar field 8.1 (only the region thereof directly at the reflector 8 is shown) in which the simulator 3 is arranged. In this case, the simulator 3 is arranged above the radar device 2 (shown next to it for the sake of clarity) and is connected to the control 6. The installation height of the reflector 8 is selected in such a way that the line of sight S between the simulator 3 and the radar receiver 2.3 is interrupted when a vehicle 9 undergoing a simple change of direction in this case is located in the line of sight S and extends from the simulator 3 to the reflector 8 and further to the radar receiver 2.3. The radar radiation travels back from the simulator 3 via the reflector 8 to the radar receiver 2.3 again as simulator signal. In this arrangement according to the invention, the radar field 2.2 is folded once vertically.

By means of the second arrangement, a radar device 2 working on the principle of FMCW-FSK can be used to obtain information about the presence of an object in the line of sight S.

In further embodiments of the arrangement according to the invention, a different quantity of reflectors 8 can be provided in different arrangements with respect to one another and/or at different distances and angles with respect to the radar device 2.

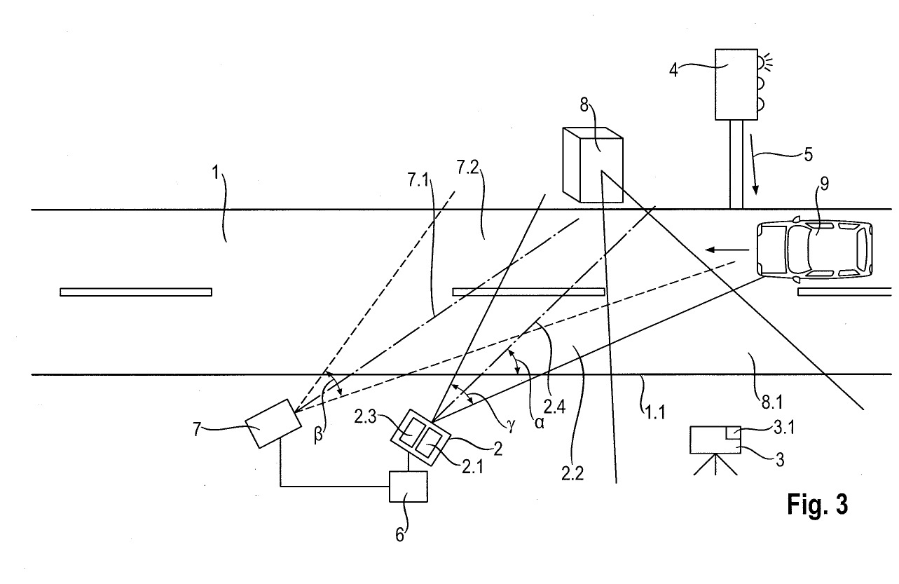

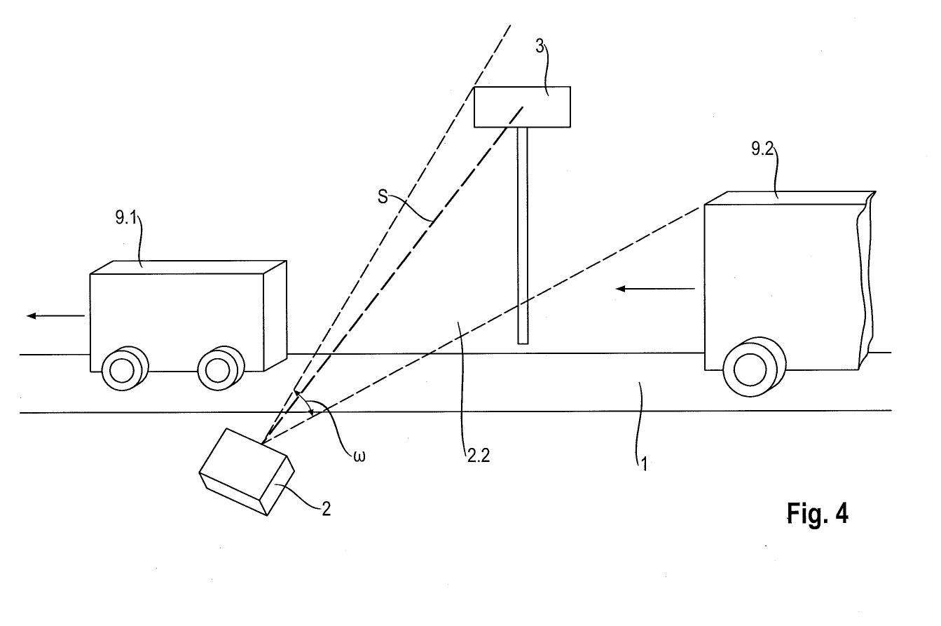

In a third arrangement, shown in FIG. 3, for use of the simulator 3, a reflector 8 which is installed in the radar field 2.2 and which reflects a portion of the radar radiation transmitted by the radar transmitter 2.1 is provided in addition to the elements described with reference to FIG. 1. The radar radiation reflected by the reflector 8 defines the second radar field 8.1 which partially overlaps radar field 2.2. The simulator 3 is installed in the second radar field 8.1. The test speeds and atypical speed profiles simulated by the simulator 3 are detectable by means of the reflection signals which are guided from the simulator 3 to the reflector 8 and subsequently from the reflector 8 to the radar receiver 2.3. In this arrangement according to the invention, the radar field 2.2 is folded once horizontally.

In further embodiments, a plurality of reflectors 8 can also be provided at different angles and/or different heights, and a plurality of second radar fields 8.1 can be defined by the reflectors 8. Further, a plurality of simulators 3 can be provided and installed in one, in a plurality of, or in different respective second radar fields 8.1.

FIG. 4 only shows the essential elements of a fourth embodiment example of the arrangement according to the invention in which the simulator 3 is arranged in an elevated manner at the opposite edge 1.1 of the roadway 1 from the radar device 2. The radar device 2 which is shown in a highly schematic manner generates a radar field 2.2 (only the vertical dimension thereof is indicated) which has a large vertical radiating angle ω. The line of sight S ascends from the radar device 2, which is mounted close to the ground, to the simulator 3 so that the line of sight S extends over the roadway 1 at a height that is greater than the height of a first vehicle 9.1. This first vehicle 9.1 moves through the radar field 2.2 without interrupting the line of sight S. A second vehicle 9.2 has a height that is greater than the height of the line of sight S over the roadway 1. If the second vehicle 9.2 is located between the radar device 2 and simulator 3, the line of sight S is interrupted by the second vehicle 9.2 and a detection of the second vehicle 9.2 takes place.

In an embodiment of the arrangement according to the invention that is not shown, the method according to the invention can also be applied when the signal device 4 is a matrix sign for displaying a currently permissible maximum speed. Depending on the currently displayed maximum speed, corresponding information about this displayed maximum speed is conveyed to the simulator control 3.1 via the data line 5, and the simulator 3 simulates an atypical speed profile that is assigned to the displayed maximum speed. The simulator signal of the atypical speed profile is received by the radar receiver 2.3 and sent to the control 6, where the simulator signal is compared with the stored assignment. After the comparison, the permissible maximum speed currently displayed by the signal device 4 is known. A speed of the vehicle 9 is derives from received reflection signals of vehicles 9 moving through the radar field 2.2 and is compared with the currently displayed permissible maximum speed. If the permissible maximum speed is exceeded, the camera 7 is actuated by the control 6 and takes at least one picture of the vehicle 9 for documenting the speed violation.

The method and the arrangement according to the invention can be used, for example, in the field of traffic monitoring of moving and stationary traffic. In addition to monitoring and documenting traffic violations, it is also possible to detect the quantity and size of the vehicles 9 traveling through the monitored area. Further, the invention is suitable for use as a motion detector.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

### REFERENCE NUMERALS

1 roadway
1.1 edge (of the roadway 1)
2 radar device
2.1 radar transmitter
2.2 radar field
2.3 radar receiver
2.4 radar axis
3 simulator
3.1 simulator control
4 signal device
5 data line
6 control
7 camera
7.1 camera axis
7.2 object field
8 reflector
8.1 second radar field
9 vehicle
9.1 first vehicle
9.2 second vehicle
S line of sight
α alignment angle (of the radar axis 2.4)
β aperture angle (of the camera 7)
γ horizontal radiating angle (of the radar transmitter 2.1)
ω vertical radiating angle (of the radar transmitter 2.1)

What is claimed is:

1. A method for detecting an object in a radar field of a radar device, comprising arranging a simulator in a stationary manner in said radar field, said radar device having a radar transmitter and a radar receiver capable of simulating a speed profile which is defined by temporally consecutive speed changes, actuating said simulator so as to simulate at least one predetermined atypical speed profile which cannot be associated with any expectable moving object, receiving simulator signals at said radar receiver caused by said simulator, and receiving status information associated with the atypical speed profile derived from said simulator signals, in addition to receiving reflection signals from objects moving through said radar field.

2. The method according to claim 1, wherein said speed profile is determined by abruptly changing speeds.

3. The method according to claim 1, wherein said status information is deduced from unchanged reception of simulator signals to the effect that no object is stopped in a line of sight between said radar device and said simulator and, correspondingly, when there is no reception, status information is deduced to the effect that at least one object is located in the line of sight.

4. The method according to claim 1, wherein said status information is deduced from the reception of indeterminately changed simulator signals to the effect that a misalignment of the radar device has occurred.

5. The method according to claim 1, further comprising selectively actuating said simulator for simulation of different speed profiles in timed correspondence to changing switch states of a traffic signal device in order to deduce the different switch states as status information from the different simulator signals.

6. The method according to one of claim 2, further comprising actuating a camera, depending on the deduced status information, when said radar receiver receives reflection signals.

7. The method according to one of claim 3, further comprising actuating a camera, depending on the deduced status information, when said radar receiver receives reflection signals.

8. The method according to claim 5, further comprising actuating a camera, depending on the deduced status information, when said radar receiver receives reflection signals.

9. The method according to claim 8, wherein different switch states of said signal device relate to a display of different permissible maximum speeds, and the different simulator signals represent different permissible maximum speeds and are compared with speeds that were derived from the reflection signals.

10. An arrangement for practicing a method according to claim 1, comprising a stationary radar device for determining a radar field, said radar device having a radar transmitter and a radar receiver, a stationary simulator in said radar field, said simulator and said radar device forming a line of sight, said simulation being suitable for the simulation of at least one predefined atypical speed profile which cannot be associated with any expectable moving object and which is determined by temporally consecutive speed changes, and a simulator control for actuating said simulator for simulation of different predefined speed profiles.

11. The arrangement according to claim 10, wherein said simulator control communicates with a traffic signal device whose switch states can change, and wherein said simulator control is configured so that said simulator can be actuated simultaneous with the change in the switch state in order to simulate different atypical speed profiles during different switch states.

12. The arrangement according to claim 10, further comprising at least one reflector arranged in said line of sight between said radar device and said simulator.

13. The arrangement according to claim 11, further comprising at least one reflector arranged in said line of sight between said radar device and said simulator.
